(19) United States
(12) Patent Application Publication
(10) Pub. No.: US 2015/0242590 A1
(43) Pub. Date: Aug. 27, 2015

(54) System for and Method of Providing Healthcare Services

(71) Applicant: HTI IP, LLC, Atlanta, GA (US)

(72) Inventor: Thomas Steven Taylor, Atlanta, GA (US)

(73) Assignee: HTI IP, LLC, Atlanta, GA (US)

(21) Appl. No.: 14/190,843

(22) Filed: Feb. 26, 2014

(51) Int. Cl. G06F 19/00

(52) U.S. Cl. CPC G06F 19/3456

(57) ABSTRACT

Systems and methods may for providing healthcare services are presented. An individual or medical provider may upload prescription information to the system. The prescription may include the medication name, the prescribed dosage, the dosage frequency, the expiration date, and/or the amount of refills available. The system may generate reminders for the individual based on the prescription information. The reminders may solicit responses from the user, to determine whether the user is taking the prescribed medication, as prescribed. The system may track the user's responses and use those responses to gauge the medications efficacy. The system may also receive health sensor data from monitoring devices associated with the user.

### BACKGROUND INFORMATION

Currently, when an individual is prescribed medication, that individual must contact the pharmacy or prescriber himself when the prescription is expired. There is no way to regularly track the individual's medication use and determined whether the user is taking the medication as prescribed. Individuals do not have a way to provide feedback about medication use in real-time.

These and other drawbacks exist.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system according to a particular embodiment;

FIG. 2 is a schematic diagram of a hardware component of the system of a particular embodiment; and

FIG. 3 is a block diagram of a method of a particular embodiment.

### DETAILED DESCRIPTION OF PREFERRED EMBODIMENTS

A system and method may include various embodiments for providing healthcare services to an individual. An individual may access one or more healthcare services provided by a healthcare services system over a network. The user may have a number of prescriptions at a pharmacy, and/or other healthcare provider. The pharmacy may provide the user's prescription information to the healthcare services system over the network. The prescription information may include the name of the medication and dosage information. The healthcare services system may send reminders to the individual's electronic devices based on the prescription information. The reminders may solicit feedback from the individual to gauge whether the individual is taking the medications as prescribed. The health services system may receive responses from the individual indicating whether the individual took the medication as prescribed.

According to an embodiment of the present invention, the healthcare services system may track the individual's medication usage, where the healthcare services system may keep track of how often the individual is taking his medication, whether he is taking the prescribed amount, and any feedback received from the individual about the medications efficacy. For example, the healthcare services system may send the individual a notification when it's time to refill a prescription and/or when the prescription is expired. The healthcare services system may regularly receive one or more health indicators and/or vital signs from the individual, such as heart rate, temperature, blood sugar level, or blood pressure. The healthcare services system may compare the health indicators with the responses received from the individual to determine whether the individual is taking the medication and whether it is effective. Also, the healthcare services system may receive location-based information from the individual's electronic device. The healthcare services system may provide directions and reminders to the individual based on the individual's prescription information and current location.

The description below describes interface modules, user profile modules, diagnostic modules, notification modules, user devices, service providers, computer systems, and networks that may include one or more modules, some of which are explicitly shown while others are not. As used herein, the term “module” may be understood to refer to computing software, firmware, hardware, and/or various combinations thereof. It is noted that the modules are examples. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

It is further noted that software described herein may be tangibly embodied in one or more physical media, such as, but not limited to, a compact disc (“CD”), a digital versatile disc (“DVD”), a floppy disk, a hard drive, read only memory (“ROM”), random access memory (“RAM”), as well as other physical media capable of storing software, and/or combinations thereof. The functions described as being performed at various components may be performed at other components, and the various components may be combined and/or separated. Other modifications also may be made.

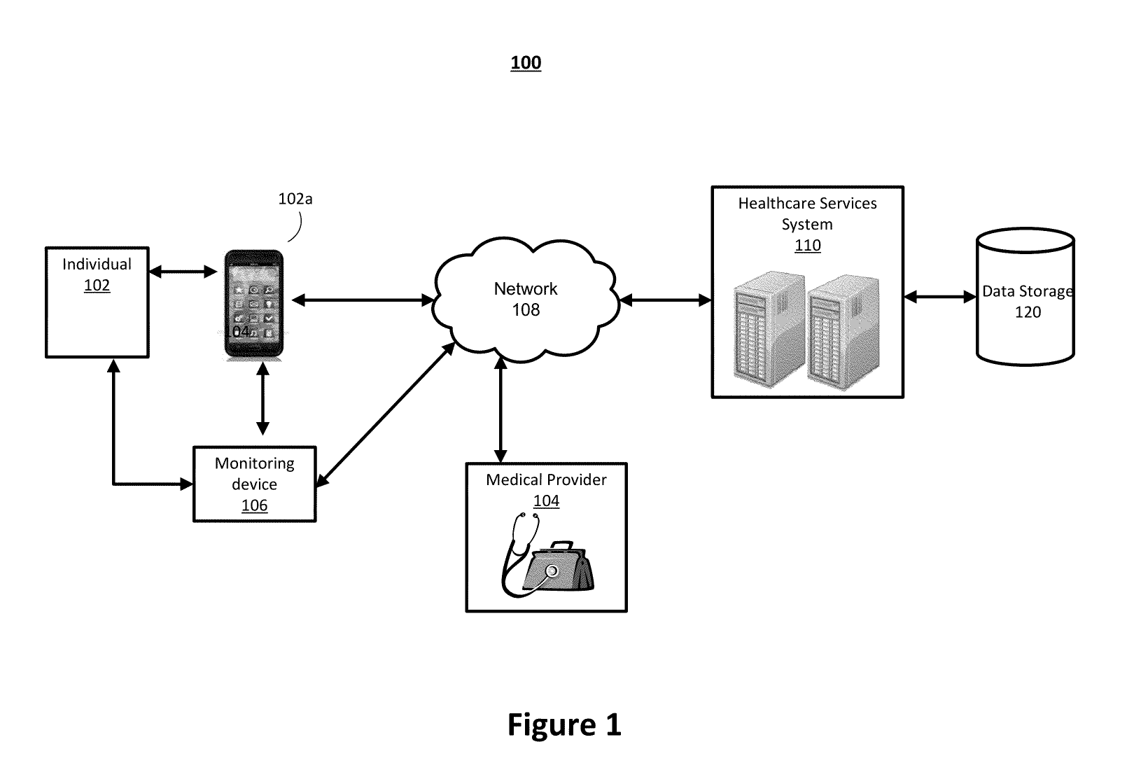

FIG. 1 is a schematic diagram illustrating a system according to a particular embodiment. A system 100 may include a user device 102a associated with user 102, medical provider 104, monitoring device 106, a network 108, data storage 120, and healthcare services system 110. Although elements of system 100 may be described as a single device, it will be appreciated that multiple instances of these devices may be included in system 100, such as, for example, multiple user devices, multiple healthcare services systems, multiple medical providers, multiple data storages, and multiple networks.

User device 102a may be, for example, but not limited to, a cellular telephone, Session Initiation Protocol (“SIP”) phone, software client/phone, a desktop computer, a laptop/notebook, a server, a module, a satellite phone, a personal digital assistant (“PDA”), a tablet computer, a smart phone, a remote controller, a personal computer (“PC”), a workstation, a handheld PC, a handheld MP3 player, a handheld video player, a personal media player, a gaming device, a thin system, a fat system, a network appliance, and/or other mobile communication device that may be capable of transmitting and/or receiving data. Also, user device 102a may include one or more transmitters, receivers, and/or transceivers to transmit and/or receive one or more signals to and/or from other components depicted in FIG. 1, including, for example, healthcare services system 110, monitoring device 106, and medical provider 104.

Medical provider 104 may provide medical services to user 102. Medical provider 104 may be a primary care facility. Medical provider 104 may be a hospital. Medical provider 104 may be a pharmacy. Medical provider 104 may be a nursing facility. Medical provider 104 may be an outpatient facility. Medical provider 104 may be one or more of a physician, nurse, physician's assistant, and/or nurse's aide.

Monitoring device 106 may be one or more devices for monitoring vital signs of user 102. Monitoring device 106 may monitor user 102's heart rate, blood pressure, temperature, blood sugar levels, breathing, and/or other vital signs of user 102. Monitoring device 106 may be physically attached to user 102. Monitoring device 106 may communicate with user device 102a and/or network 108 using one or more wireless or wired connections.

Network 108 may be a wireless network, a wired network, or any combination of wireless network and wired network. For example, network 108 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, network 108 may include, without limitation, telephone line, fiber optics, IEEE Ethernet 802.3, a wide area network (“WAN”), a local area network (“LAN”), or a global network such as the Internet. Also, network 108 may support, an Internet network, a wireless communication network, a cellular network, or the like, or any combination thereof. Networks 108 may further include one, or any number of the exemplary types of networks mentioned above operating as a stand-alone network or in cooperation with each other. Network 108 may utilize one or more protocols of one or more network elements to which it is communicatively coupled. Networks 108 may translate to or from other protocols to one or more protocols of network devices. Although network 108 is depicted as one network, it should be appreciated that according to one or more embodiments, network 108 may comprise a plurality of interconnected networks, such as, for example, a service provider network, the Internet, a broadcaster's network, a cable television network, corporate networks, and home networks.

The components depicted in FIG. 1 may transmit and receive data to and from network 108 representing broadcast content, user request content, parallel search queries, parallel search responses, and other data. The data may be transmitted and received utilizing a standard telecommunications protocol or a standard networking protocol. For example, one embodiment may utilize Session Initiation Protocol (“SIP”). In other embodiments, the data may be transmitted and/or received utilizing other Voice Over IP (“VOIP”) or messaging protocols. For example, data may also be transmitted and/or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 108 may use standard wireless protocols including IEEE 802.11a, 802.11b and 802.11g. Network 108 may also use protocols for a wired connection, such as an IEEE Ethernet 802.3.

Data storage 120 may be network accessible storage and may be local, remote, or a combination thereof to the components depicted in FIG. 1. Data storage 120 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage 120 may be a database, such as an Oracle database, a Microsoft SQL Server database, a DB2 database, a MySQL database, a Sybase database, an object oriented database, a hierarchical database, or other database. Data storage 120 may utilize flat file structures for storage of data. Data storage 120 may be communicatively coupled to healthcare services system 110, or to any other component depicted in FIG. 1. Any of the other components depicted in FIG. 1 may include one or more data storages as well.

Healthcare services system 110 may include one or more devices, modules, and/or components for providing routing information for transmitting data over a network, such as, for example, an IP network and/or a PSTN. Healthcare services system 110 may include a virtualized data storage pool hosted by one or more third parties, such as a service provider (not shown), and/or medical provider 104. Healthcare services system 110 may comprise one or more distributed servers and may be used to store data objects for access by user device 102a, medical provider 104, monitoring device 106, and/or network 108. Healthcare services system 110 may be accessed through a web service application programming interface (API), a cloud storage gateway or through a web-based user interface accessible by user 102 and/or medical provider 104. Healthcare services system 110 may be accessed through an application on user device 102a. Healthcare services system 110 may communicate data with user device 102a, medical provider 104, and/or monitoring device 106 using one or more networks, such as network 108.

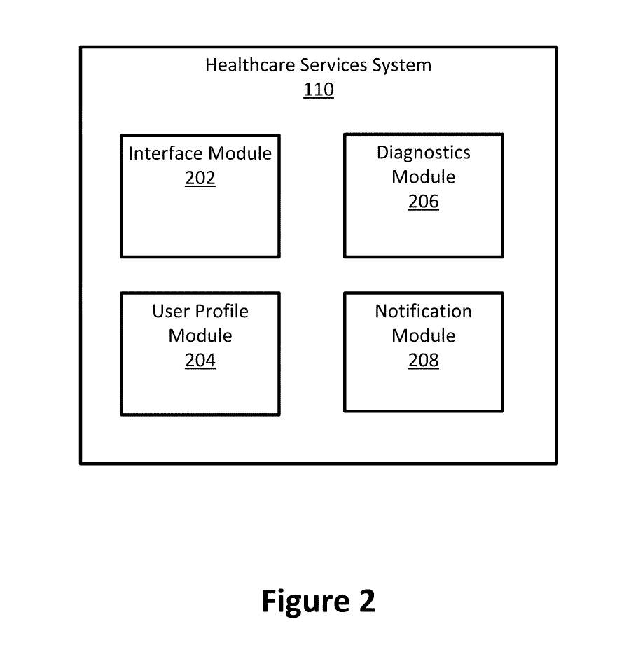

Healthcare services system 110 may include an interface module, a user profile module, a diagnostic module, and a notification module, as described herein in reference to FIG. 2. Also, in various embodiments, healthcare services system 110 may be a resolution server or may be a module of, or communicatively coupled to, a Domain Name System (“DNS”) server, such as a BIND server, for converting host names and domain names into IP addresses over the Internet.

Healthcare services system 110 may comprise one or more network enabled computers. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. In other embodiments, healthcare services system 110 may be implemented as part of a software application on a user device. For example, healthcare services system 110 may be implemented as a mobile application on user device 102a.

FIG. 2 is a block diagram of a hardware component of an example embodiment of healthcare services system 110. For example, healthcare services system 110 may include an interface module 202, a user profile module 204, a diagnostics module 206, and a notification module 208. It is noted that modules 202, 204, 206, and 208 are exemplary and the functions performed by one or more of the modules may be combined with that performed by other modules. The functions described herein as being performed by modules 202, 204, 206, and 208 may also be separated and may be performed by other modules at devices local or remote to healthcare services system 110. The modules may each be a computer program or an appropriately programmed computer, such as a mainframe or personal computer, or may include a plurality of such computers cooperating to perform the functionality described herein. Modules 202, 204, 206, and 208 may also communicate with data storage 120. Modules 202, 204, 206, and 208 may also be coupled to or integrated with healthcare services system 110 or medical provider 104. For example, modules 202, 204, 206, and 208 may be external devices that are wirelessly coupled and/or communicatively coupled to healthcare services system 110 via an interface port which may include, without limitation, USB ports, system bus ports, or Firewire ports and other interface ports. Further, computer code may be installed on healthcare services system 110 to control and/or operate a function of interface module 202, user profile module 204, diagnostics module 206, and/or notification module 208.

A user 102 may have a profile or account with health services system 110. The user's profile information may be stored in data storage 120. The profile information may include a username, password, phone number, email address, physical address, social media information, and other data that uniquely identifies user 102. The user profile may include the user's height, weight, age, body mass index (BMI), and medical history.

Interface module 202 may allow user 102 to access his or her profile at healthcare services system 110. User 102 may access his profile using user device 102a. The profile may be accessed using a local application on user device 102a. The profile may be accessed using a web-based interface. User 102 may supply a username and/or password to access his profile. User profile module 204 may compare the username and/or password provided by user 102 with the usernames and passwords stored at data storage 120 and associated with known user profiles. Interface module 202 may allow user 102 to create a new profile and supply user 102's information. Interface module 202 may create a username and password, or allow user 102 to create a username and password.

The profile may include health information. The health information may include prescription information. The prescription information may include the name of the medication (or medications), the prescriber, a prescription number, the name, phone number, and physical address of the pharmacy and/or medical facility where the prescription is filled, and dosage information (such as dates and times that the medication should be taken). The health information may be provided by user 102, medical provider 104, and/or a third party. User 102 may have a prescription with medical provider 104. Medical provider 104 may provide the prescription information to health services system 110, using interface module 202. User 102 may allow medical provider 104 to provide health information that is stored with the user's profile.

User profile module 204 may be configured to allow user 102 to designate medical providers that are permitted to upload health information to the user's profile. If user 102 designates medical provider 104, notification module 208 may send a notification to medical provider 104 that includes login information that medical provider 104 can use to upload health information to the user's profile using interface module 202. Interface module 202 may provide a different interface to medical provider 104.

In another embodiment, medical provider 104 may request access to user 102's profile using interface module 202. Once medical provider 104 has requested access, notification module 208 may send a notification to user device 102a, informing user 102 that medical provider 104 is requesting access and giving user 102 the option of logging into his profile (using interface module 202) and granting medical provider 104 permission (e.g., by typing in the name of the medical provider, by selecting the medical provider from a list). The notification may allow the user to grant medical provider 104 simply by clicking a hyperlink embedded in the notification, or by responding affirmatively to the notification.

If user 102 has a prescription with medical provider 104—and medical provider 104 has been given access to user 102's profile as described above—medical provider 104 may use interface module 202 to access the profile of user 102 and upload the prescription information. User profile module 204 may receive the prescription information and update the user's profile in database 120.

The prescription information may include the date the prescription was filled. The prescription information may include the date the prescription expires. The prescription information may include dosage information, including the amount user 102 is supposed to use and the frequency of use. Notification module 208 may access the prescription information for user 102. Notification module 208 may determine whether to create a reminder to send to user 102 based on the current date and time and the prescription information.

In one example embodiment, if notification module 208 determines that the prescription has expired and needs to be refilled, notification module 208 may send a reminder to user device 102a and/or medical provider 104. The reminder may inform user 102 that the prescription is expired. The reminder may provide the date of expiration. The reminder may include contact information and/or directions to medical provider 104. The reminder may include interactive features that solicit whether user 102 would like to have the prescription automatically refilled by medical provider 104. If user 102 responds affirmatively, user profile module 204 may receive the response, and notification module 208 may send a refill request to medical provider 104 based on the received response.

Based on the prescription information, notification module 208 may send a reminder to user device 102a at a date and time corresponding to when user 102 is supposed to take medication. The reminder may include interactive elements soliciting feedback from user 102. The reminder may inquire whether the user took the medication at the scheduled time. The reminder may include the name of the medication, the prescribed dosage, contact information for the medical provider 104, and other information. The reminder may include interactive features that allow the user to respond to queries. The user may respond “yes” or “no” on user device 102a. The user may select a response from a predetermined list. The user may type in a response or provide a verbal response. The response may be received by user profile module 204. The response may be stored with the user's profile information as response data.

As used herein, the reminder may comprise one or more of a text message, SMS/MMS message, an email, a message sent via a social media service, or other electronic communication. User 102 may view the reminder on user device 102a. The reminder may include interactive features, graphical user interfaces, text, images, hyperlinks, and/or digital videos.

Notification module 208 may send a reminder each hour, day, week, or at some other regular interval, based on the prescription information. User 102 may access his profile to designate how often a reminder should be sent to his user device 102a.

In one embodiment, user 102 may have a prescription for Norvasc at a pharmacy. User 102 may have given the pharmacy permission to upload the prescription information to the user's profile using healthcare services system 110. The prescription information may note that user 102 should take two Norvasc tablets per day. The prescription may be for a bottle of 50 tablets. The prescription may allow for one refill. The prescription information may note that the medication expires by Apr. 1, 2014. User profile module 204 may store this information with the user 102's profile information at data storage 120.

Notification module 208 may send a reminder to user device 102a every day, based on the prescription information. The reminder may be sent at the same time each day, which user 102 may have previously selected using interface module 202. The reminder may include an interactive feature that asks user 102 whether he took the two Norvasc as prescribed. The reminder may allow the user to enter the number of Norvasc tablets he took that day. The reminder may ask the user the time of day when he took the Norvasc. If the user responds that he did not take the Norvasc that day, notification module 208 may generate follow-up questions to ask user 102 why he did not take the Norvasc (e.g., “Do you need a refill?”, “Are the pills defective?”, “Are they ineffective?”). If the user fails to respond within a predetermined amount of time, notification module 208 may send a second reminder within a certain period of time, and additional reminders thereafter if the user does not respond. The reminder may ask the user to rate the amount of pain he is feeling (e.g., on a scale of 0 to 10). User 102 may respond using user device 102a. The responses may be received by user profile module 204 and stored as response data with user 102's profile information in data storage 120. The reminder may ask user 102 if he is taking any other medication, and if so, what medication and how often.

User profile 204 may keep track of the user's response data and provide it to user 102 and/or medical provider 104 if requested. For example, user profile module 204 may keep track of whether user 102 took the prescribed medication each day. Profile module 204 may present user 102's medication history to user 102 and/or medical provider 104 via interface module 202. The response data may be presented as a chart, a graph, an image, or in some interactive form. If the user is taking multiple medications, user profile module 204 may allow user 102 to view the response data for each medication he is taking.

User profile 204 may update the prescription information in the user profile based on the response data. For example, each time the user responds affirmatively that he took his medication, user profile module 204 may reduce the total amount of medication remaining on the prescription. If the prescription was for 50 tablets, and the user is required to take two tables per day, each time the user responds affirmatively that he has taken two tablets, user profile module 204 may reduce the total by two and save the updated total in the user's profile. If user profile module 204 determines that a certain minimum amount of tablets remain, notification module 208 may send a reminder to user device 102a informing user 102 that he is almost out of medication and requesting whether the user would like to have the prescription refilled. If user 102 responds affirmatively (using the interactive features on the notification), notification module 208 may send a request for a refilled prescription to medical provider 104 and provide instructions to user 102 as to when and where he can pick up his refilled prescription.

User 102 may be a caregiver for a patient. For example, user 102 may work in a nursing home and provide care to residents there. User 102 may manage multiple profiles for multiple residents, and upload prescription and other information for each resident. User 102 may receive multiple notifications and/or reminders on user device 102a, and in this way healthcare services system 110 may keep track of which resident needs to take which medication. User 102 may be a family member who assists a sick relative and helps that relative take his or her medication at specified times.

Diagnostic module 206 may receive sensor data from monitoring device 106. Monitoring device 106 may be associated with user 102. The sensor data may include, without limitation, user 102's temperature, heart rate, blood pressure, blood sugar level, and/or breathing rate. If user 102 is a caregiver, monitoring device 106 may be associated with a patient that user 102 is caring for. Diagnostic module 206 may receive the sensor data and store it in the user's profile. Sensor data may include a date and time that the data was recorded by monitoring device 106. Diagnostic module 206 may correlate the sensor data with user 102's prescription information and user 102's response data. Diagnostic module 206 may compare the sensor data with the prescription information in order to determine whether the prescription is effective. For example, if user 102 is taking medication to help lower his blood pressure, diagnostic module 206 may receive sensor data that includes regular blood pressure readings. Notification module 208 may send reminders to user device 102a, alerting user 102 to take his blood pressure medication at certain times and requesting a confirmation from user 102 that he took the medication. If user 102 responds in the affirmative, diagnostic module 206 may compare the response data with the sensor data to determine whether the medication is lowering user 102's blood pressure. If the blood pressure readings are not lowering, diagnostic module 206 may send notifications to medical provider 104, wherein the notifications may include the sensor data. Medical provider 104 may decide to prescribe a different medication, increase or decrease the prescribed dosage, increase or decrease the frequency of use, or other steps.

If diagnostic module 206 determines that the sensor data indicates that the medication is not working as prescribed, notification module 208 may send one or more reminders to user device 102a requesting confirmation that user 102 took the medication at the prescribed time and in the prescribed manner. Diagnostic module 206 may confirm whether the prescription has expired by analyzing the prescription information in the user profile. Diagnostic module 206 may store the sensor data in the user profile in data storage 120.

When user 102 responds to notifications and reminders sent by notification module 208, the response data could include location data from user device 102a. The location data could correspond to the current location of user device 102a. User device 102a may include GPS technology and/or geolocation technology. Notification module 208 may send reminders based on the location data. For example, the reminder may include a map to one or more pharmacy's and/or other medical providers that are within a certain distance of user device 102a's current location. The notification could provide directions to medical provider 104, if medical provider 104 is the main medical provider for user 102.

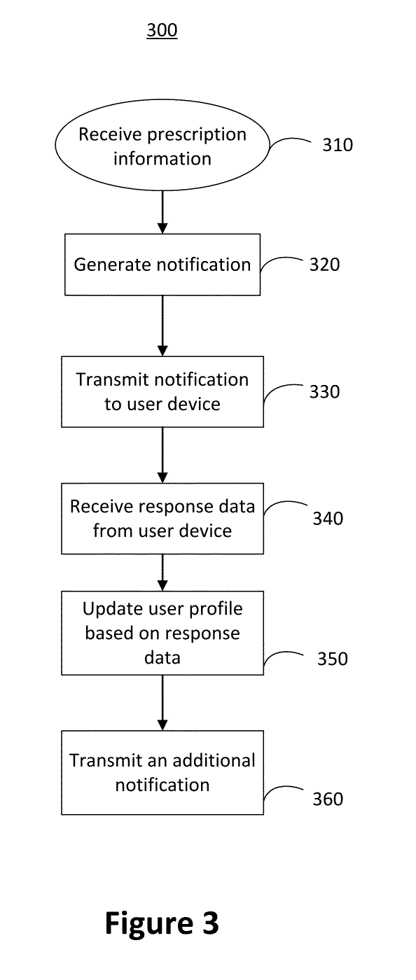

FIG. 3 is a flowchart illustrating the functionality of a method for providing healthcare services. This method is provided by way of example, as there are a variety of ways to carry out the methods described herein. Method 300 shown in FIG. 3 may be executed or otherwise performed by one or a combination of various systems. The method 300 may be carried out through system 100 of FIG. 1 and/or the one or more modules shown in FIG. 2, by way of example, and various elements of FIG. 1 and FIG. 2 are referenced in explaining method 300 of FIG. 3. Each block shown in FIG. 3 represents one or more processes, methods, or subroutines carried out in method 300. Method 300 may begin at block 310.

At block 310, method 300 may receive prescription information associated with a user of a user device. The prescription information may be received from the user device. The prescription information may be received from a medical provider. The prescription information may include the name of the medication or medications that the user is taking, total amount prescribed, the number of times per day, week, and/or month that the user is required to take the medication, the amount of medication that the user should take with each dosage, the date the prescription expires, the contact information for the prescriber, and other information. For example, the user may be diabetic and receive a prescription for an insulin pen. The prescription may include the total amount (e.g., 1 pen with 300 units of insulin), the amount the user should take (15 units/day), the date prescribed (Mar. 1, 2014), the date the medication expires (Aug. 1, 2014), the contact information for the prescriber, and other relevant information. The prescription information may be stored with a profile associated with the user. Method 300 may proceed to block 320.

At block 320, method 300 may generate a notification for the user. The notification may be based in part on the prescription information. The notification may be based in part on the current date and time. The notification may include interactive features. Continuing with the previous example, the notification may be based on the user's insulin prescription. The notification may be generated every day (based on the fact that the prescription requires the user to take the insulin once per day). The notification may include the daily dosage amount (15 units). The notification may include the contact information for the prescriber. The notification may include the contact information and/or location information for a nearby pharmacy. The notification may be generated at the same time each day. The notification may include interactive features that solicit a response from the recipient. The notification may be generated based on a determination that the medication has expired. Method 300 may proceed to block 330.

At block 330, method 300 may transmit the notification to a user device associated with the user who has the prescription. The notification may be an electronic communication, such as, e.g., an email, text message, SMS/MMS message. The notification may be sent to the user device when it is generated. The notification may solicit feedback from the user of the user device. The notification may ask the user if he or she took her medication that day. Continuing with the previous example, the notification may be sent to the user at 9 am each day. The notification may include the message “Did you take your 15 units of insulin today?” The notification may include an interactive feature allowing the user to respond “Yes” or “No”. Based on the current date and time, the notification may inform the user that “your prescription expires in [x] days.” Method 300 may proceed to block 340.

At block 340, method 300 may receive response data from the user device. The response data may be received in response to the notification. The response data may be responses to one or more questions posed to the user by the notification. Continuing with the previous example, the user may respond to the notification asking if he took his 15 units of insulin with a “yes.” The user may respond with “no.” The user's response may be a string of text. The user may send a voice response. Method 300 may proceed to block 350.

At block 350, method 300 may update the user's profile based on the response. If the user responded “yes” to the notification question asking whether he took his 15 units of insulin that day, the profile may be updated to reduce the total amount of insulin available on the prescription. For example, if the profile previously indicated that there were 240 units of insulin remaining on the prescription, and the response data just received indicates that the user took the 15 units, the new total may be updated to be 225 units of insulin remaining. The response data may indicate that the user only took 10 units, and the total would be updated accordingly. The response data may be saved in the user profile for each date and time it was received. If the user responded “no,” this may be saved. The data may be stored and associated with multiple medications that the user is taking Method 300 may proceed to block 360.

At block 360, method 300 may transmit an additional notification. The additional notification may be based on the received response data. If the user responded “no” to the first notification that asked if the user took his insulin for that day, the additional notification may solicit additional feedback. For example, it may request that the user explain why he or she did not take her insulin and provide the user with one or more possible response options (e.g., “I'm out of medication”, “I'm not feeling well”, “Medication has expired”, “Side effects”). The additional notification may include interactive features that allow the user to respond (as with the first notification). The user's responses may be used to further update the user profile and generate additional notifications.

The additional notification may be based on the user profile. For example, if the prescription information in the user profile indicates that the user only has a predetermined amount of medication left, the additional notification may inform the user that “you only have [x] units remaining on your prescription” and include interactive features asking the user whether he wants to have the prescription refilled. If the user responds affirmatively, the medical provider and/or pharmacy may be automatically contacted with a request for a refilled prescription.

In some embodiments, the user may also be equipped with one or more monitoring devices, which may include one or more sensors to detect and measure physiological changes in the user. The monitoring devices may measure, without limitation, the user's temperature, heart-rate, blood pressure, blood sugar level, blood oxygen level, various blood chemistry parameters, muscle tension, and breathing rate, among other parameters. The sensors may collect this user health information and send it to the user device, which may transmit the information along with the response data in step 340. The sensors may transmit the information directly to the healthcare services system. In an aspect, the sensor information may replace the response data received at step 340 insofar as the sensor information and data may indicate whether a user's body received his, or her, medication based on changes to the body as indicated by the sensor data.

For example, if a user is supposed to take medication to lower his blood pressure in the morning at 9:00 A.M., but the sensor data received at step 340 does not indicate a decrease in blood pressure around 9:00 A.M. as it normally does following administering of the pressure-lowering medication (based on the user's height, weight, age, and medical history), device 102a or system 110 may generate an notification, alert, or message, reminding the user to take the blood pressure medication. In step 350, the healthcare services system may update the user profile based on the user health information (sensor data) and the response data. In an aspect, if the sensor data indicates that user 102's blood pressure has lowered as expected (based on the user health information and/or prior readings stored in the user's profile), device 102a or system 110 may automatically confirm that the user took the medication (and update the user profile accordingly), and/or may generate a notification to device 102a that requests that the user manually confirm that he took the blood pressure medication the data corresponding to his body indicates. The healthcare services system may compare the user health information with the user's prescription information and/or the user's profile, and may use the results of the comparison to update the profile (e.g., to indicate that the effect of blood pressure medication may be changing).

In an aspect, if the user's prescription information indicates that the user is taking a blood pressure medication, the healthcare services system may periodically receive blood pressure readings for the user. Healthcare services system may compare the blood pressure readings with predicted blood pressure readings based on the user's height, weight, age, medical history, and the prescription information. In this way, healthcare services system may determine whether the blood pressure medication is effective and/or whether the user is taking the medication as prescribed. The notifications created in steps 330 and 360 may be based on this comparison (e.g., the notification may query the user as to whether he is taking the medication as prescribed if the user health information indicates that the user's blood pressure is higher than it should be).

The various computing devices above (including phones and network equipment), generally include computer-executable instructions, where the instructions may be executable by one or more processors. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

Databases, data repositories or other data stores described herein, such as the data storage 120, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system, comprising:
a processor; and
a memory comprising computer-readable instructions which when executed by the processor cause the processor to perform the steps comprising:
receiving health information associated with a user profile;
generating a notification for the user based at least in part on the health information and the current date and time;
transmitting the notification to a user device associated with the user profile;
receiving a response from the user device;
updating the user profile based at least in part on the response; and
determining whether to generate a second notification based at least in part on the response.

2. The system of claim 1, wherein the health information comprises at least one of a prescription number, patient's name, quantity of tablets or capsules, medication name, prescribed dosage, a frequency of use, prescriber information, a prescription date, and an expiration date.

3. The system of claim 2, wherein the notification includes one or more interactive features to solicit a response from the user associated with the user device, wherein the response is transmitted by the user device based at least in part on the user selecting the one or more interactive features.

4. The system of claim 2, wherein the notification includes at least one of a reminder to the user to take a specified quantity of medication, a reminder to the user that a medication has expired, and a reminder to the user to refill a prescription.

5. The system of claim 3, wherein the response comprises at least one of an indication that the user has taken medication at the prescribed dosage, an indication that a user has not taken medication, and an indication that the user has taken the medication but not at the prescribed dosage.

6. The system of claim 5, wherein the determination of whether the second notification is generated is based on whether the response comprises an indication that the user has not taken the medication.

7. The system of claim 2, wherein memory comprising computer-readable instructions which when executed by the processor cause to perform the additional steps comprising:
receiving sensor data from a device associated with the user;
comparing the sensor data to the user profile; and
transmitting a third notification to the user based on the results of the comparison between the sensor data and the user profile.

8. The system of claim 7, wherein the sensor data comprises a measurement of at least one of the blood pressure of the user, the heart rate of the user, the blood sugar level of the user, the temperature of the user, and the breathing rate of the user.

9. The system of claim 2, wherein the user profile comprises a list of dates and times a user has taken medication.

10. A method, comprising:
receiving health information associated with a user profile;
generating, using at least one computer processor, a notification for the user based at least in part on the health information and the current date and time;
transmitting the notification to a user device associated with the user profile;
receiving a response from the user device;
updating the user profile in a database based at least in part on the response; and
determining whether to generate a second notification based at least in part on the response.

11. The method of claim 10, wherein the health information comprises at least one of a prescription number, patient's name, quantity of tablets or capsules, medication name, prescribed dosage, a frequency of use, prescriber information, a prescription date, and an expiration date.

12. The method of claim 11, wherein the notification includes one or more interactive features to solicit a response from the user associated with the user device, wherein the response is transmitted by the user device based at least in part on the user selecting the one or more interactive features.

13. The method of claim 11, wherein the notification includes at least one of a reminder to the user to take a specified quantity of medication, a reminder to the user that a medication has expired, and a reminder to the user to refill a prescription.

14. The method of claim 12, wherein the response comprises at least one of an indication that the user has taken medication at the prescribed dosage, an indication that a user has not taken medication, and an indication that the user has taken the medication but not at the prescribed dosage.

15. The method of claim 14, further comprising generating the second notification if the response comprises an indication that the user has not taken the medication.

16. The method of claim 11, wherein the user profile comprises a list of dates and times a user has taken medication.

17. A method, comprising:
receiving health information associated with a user profile;
receiving sensor data from a device associated with the user;
generating, using at least one computer processor, a notification for the user based at least in part on the health information, the current date and time, and the sensor data;
transmitting the notification to a user device associated with the user profile;
receiving a response from the user device; and
updating the user profile in a database based at least in part on the response.

18. The method of claim 17, wherein the sensor data comprises a measurement of at least one of the blood pressure of the user, the heart rate of the user, the blood sugar level of the user, the temperature of the user, and the breathing rate of the user.

19. The method of claim 18, wherein the health information includes an expected outcome for a medication that the user has been prescribed, wherein the notification is generated based on a comparison between the expected outcome and at least a portion of the sensor data.

20. The method of claim 19, further comprising updating the user profile based in part on the sensor data.
